(19) United States
(12) Patent Application Publication
(10) Pub. No.: US 2011/0191770 A1
(43) Pub. Date: Aug. 4, 2011

(54) DOWNLOAD PROGRAM, INFORMATION STORAGE MEDIUM, DOWNLOAD SYSTEM AND DOWNLOAD METHOD

(75) Inventor: Tatsuya Inoue, Tokyo (JP)

(73) Assignee: Sourcenext Corporation, Minato-ku, Tokyo (JP)

(21) Appl. No.: 12/599,665

(22) PCT Filed: Aug. 2, 2007
(86) PCT No.: PCT/JP2007/065148

§ 371 Date: Nov. 10, 2009

(30) Foreign Application Priority Data
May 11, 2007 (JP) 2007-126776

(51) Int. Cl. G06F 9/445

(52) U.S. Cl. 717/178

(57) ABSTRACT

A download program causes a computer to function as: a user identification information section that acquires a user identification (ID) information; a download section that downloads a download file including a compressed target program determined based on the acquired user ID information from the server through the network, and stores the download file in a predetermined download file storage area; an extraction section that extracts the compressed target program included in the download file stored in the predetermined download file storage area by the download; and an installation program execution section that executes an installation program for installing the extracted target program in the computer.

### TECHNICAL FIELD

The present invention relates to a download program for downloading a program to a computer, an information storage medium, a download system, and a download method.

### BACKGROUND ART

FIG. 15 is a flowchart showing a related-art download method for downloading a program from a server to a computer through a network.

The following description is given taking an example in which the user connects a computer (e.g., personal computer (PC)) to a network (e.g., Internet), purchases a program at a store site through the Internet, and downloads the purchased program.

The user accesses the store site using the computer through a web browser (step S510). The user clicks a purchase button while specifying the desired application program to complete the purchase (step S512). The user then accesses a “My Download” page (step S514). The user clicks the desired product from the product list on the “My Download” page (step S516). When a dialog “store or execute” has been displayed, the user selects the item “store” (step S518). When a storage location designation dialog has been displayed, the user selects the storage location and stores the product (step S520). The user then double-clicks on the stored file (step S522). When an extraction destination designation dialog has been displayed, the user selects the extraction destination and extracts the product (step S524). When a new folder has been created as a result of extraction, the user opens the folder (step S526). The user finds an installation program from a plurality of files and double-clicks on the installation program (step S528). The installation program is thus executed (step S530).

FIG. 14 is a flowchart showing an installation method using a commonly used installation program.

When the user has inserted a CD-ROM or a DVD-ROM that stores an installation target program into a CD-ROM drive or a DVD-ROM drive provided in a computer (e.g., personal computer (PC)), or has downloaded the installation target program through the Internet, an installer included in the installation target program is executed so that installation of the installation target program starts (step 501).

When installation of the installation target program has started, a license agreement is displayed on the first screen, and the user clicks a button that indicates whether or not to accept the license agreement (step 502). When the user has selected the button “do not accept”, installation of the installation target program is immediately terminated.

When the user has selected the button “accept” in the step 502, installation of the installation target program proceeds, and the user selects custom installation or default installation (recommended installation) (step 503).

When the user has selected custom installation in the step 503, a checklist screen for selecting each function of the installation target program is displayed so that the user can make detailed settings (step 504).

When the user has selected recommended installation in the step 503, or has completed the detailed settings of custom installation (step 504), a screen for designating the installation destination (storage location) of the installation target program is displayed (step 505). A default (recommended) installation destination is normally displayed on this screen. When the user desires to change the installation destination, the user selects a “change” or “browse” button (step 505).

When the user has selected the “change” or “browse” button in the step 505, a screen for designating the installation destination (storage location) of the installation target program is displayed, and the user designates the desired installation destination (step 506).

When the user has selected an “OK” or “next” button in the step 505, or has designated the desired installation destination in the step 506, the installation target program is installed (step 507).

The installation target program can be thus installed in a computer such as a PC and can be executed on the computer. Japanese Patent No. 3333737 discloses technology in this field, for example.

### DISCLOSURE OF THE INVENTION

As shown in FIGS. 14 and 15, a related-art program download/installation method requires the user to input a plurality of instructions. In particular, it is difficult for an inexperienced user (e.g., elderly person and children) to input instructions (e.g., folder designation) or execute the installation program. Therefore, there may be a case where an inexperienced user cannot download or install the program due to such an instruction input operation.

The invention was devised in view of the above-described problems. An object of the invention is to provide a download program that can download a program to a computer and install the program in the computer without an input from the user and a click operation, an information storage medium, a download system, and a download method.

(1) According to one aspect of the invention, there is provided a download program that downloads a program from a server to a computer through a network, the download program causing the computer to function as:

a user identification information acquisition section that acquires a user identification (ID) information;

a download section that downloads a download file including a compressed target program determined based on the acquired user ID information from the server through the network, and stores the download file in a predetermined download file storage area;

an extraction section that extracts the compressed target program included in the download file stored in the predetermined download file storage area by the download; and

an installation program execution section that executes an installation program for installing the extracted target program in the computer.

The user ID information may be registered in the download program in advance (e.g., registered when installing the download program or during initial startup), or the download program may issue an input request to the user and acquire the user ID information from the user based on the input information from the user. The user ID information may be an identification information which can be uniquely associated with the user.

The target program is a general-purpose application program or the like.

The target program determined based on the acquired user ID information refers to a program corresponding to a product purchased using the user ID information, for example.

The predetermined download file storage area may be a download file folder allocated by the download program, or may be a default folder provided by the computer.

The download section may download an executable file (EXE file) that contains a compressed file and an (uncompressed) self-extracting program that self-extracts the compressed file. The extraction section may execute the self-extracting program as the process of extracting the compressed file. The compressed file is automatically extracted by executing the self-extracting program.

The download section may download a compressed file, and the extraction section may execute an extraction program installed in advance to extract the downloaded compressed file.

The download file may include a target program and an installation program for installing the target program in the computer. In this case, the installation program execution section may execute the installation program included in the download file. The installation program may be executed by issuing a command for executing the installation program in the download program.

A number of steps which normally involve the user (e.g., designation of the download destination folder, a compressed file extraction process, and execution of the installation program) can be automatically performed without requiring an input from the user by utilizing the download program according to this aspect of the invention. Therefore, an inexperienced user can easily download a program.

According to this aspect of the invention, a convenient download environment that enables an application program purchased by the user on a website through the Internet to be automatically downloaded and installed can be provided.

Moreover, it is possible to implement a convenient download system that can deal with the case where the user desires to reinstall a program by utilizing the download program.

(2) The download program according to another aspect of the invention may further comprise:

a file information acquisition section that acquires file information relating to the download file that can be downloaded,

wherein at least one of a download process, a compressed file extraction process, and an installation program execution process is performed by using the acquired file information.

The file information refers to information relating to the download file corresponding to the product registered as a downloadable product corresponding to the user ID information. For example, the download file information includes at least one of the file size, the address, and the file list of the download file, the destination folder name, the file name of the installation program, the file name of the self-extracting program, and extension information (e.g., information relating to whether or not a reboot is necessary), and is expressed in an XML format or the like.

The file information acquisition section may include a subsection that requests the server to transmit the file information relating to the download file that can be downloaded from through the network based on the acquired user ID information, and a subsection that receives the file information corresponding to the request from the server through the network.

The download section may download the download file based on the acquired file information. For example, the download means may issue a file transfer request based on the acquired file address (i.e., one piece of the file information).

The installation program execution section may execute the installation program based on the acquired file information. For example, the installation program execution means may execute the installation program based on the acquired file name of the installation program (i.e., one piece of the file information).

The extraction section may extract the compressed file included in the download file based on the acquired file information. For example, the extraction means may designate the destination folder based on the acquired destination folder name (i.e., one piece of the file information).

According to this aspect of the invention, since the download program receives the file information relating to the download file from the server and performs the download process based on the file information, the download file can be automatically download without requiring an input from the user by receiving the information necessary during download as the download file information.

According to this aspect of the invention, the information necessary when downloading the download file, extracting the compressed file, or installing the program is provided in the server as the file information. The download program of the local computer acquires the file information, and sets parameters necessary when downloading the download file, extracting the compressed file, or installing the program based on the acquired file information. Therefore, download, extraction, and execution of the installation program can be automatically performed without instructions input from the user.

(3) In the download program according to another aspect of the invention,

the download file may include a target program and an automatic installation program for installing the target program;

the automatic installation program may implement an automatic installation process that installs the target program at a predetermined installation destination without receiving input information from a user; and

the installation program execution section may execute the automatic installation program.

When the automatic installation program included in the download file is compressed, the automatic installation program is extracted and executed.

The automatic installation process includes copying the executable file of the target program to the installation destination folder, registering the executable file of the target program in the registry of the system of the computer, and registering the executable file of the target program in the start menu, for example. In this aspect of the invention, these processes are automatically performed without receiving the input information from the user.

The installation program may be configured so that automatic installation or custom installation can be selected.

The installation program may be configured so that automatic installation is performed when a selection signal for automatic installation or custom installation has not been input within a predetermined period of time.

According to this aspect of the invention, since the automatic installation program included in the download file is automatically executed by executing the download program, a series of processes from download to installation can be automatically executed without requiring an input from the user.

Moreover, since the automatic installation program allows installation to be completed without receiving the input information from the user, a series of processes from download to installation can be automatically executed without requiring an input from the user.

(4) In the download program according to another aspect of the invention,

the download section may receive the download file according to a predetermined file transfer protocol without using a web browser.

The predetermined file transfer protocol may be an FTP, for example.

(5) In the download program according to another aspect of the invention,

the download section may include:

a program information request section that requests the server to transmit downloadable program information through the network based on the acquired user ID information;

an output section that outputs a download program selection screen based on the downloadable program information received from the server through the network in response to the request, the download program selection screen displaying a downloadable program list and accepting download program selection information;

a transfer request section that issues a file transfer request for the download file including the target program corresponding to the download program selection information accepted through the download program selection screen to the server through the network, based on the download program selection information; and

a download file storing section that stores the download file received in response to the file transfer request in the predetermined download file storage area.

(6) The download program according to another aspect of the invention may further comprise a decryption section that decrypts a downloaded encrypted program.

(7) According to another aspect of the invention, there is provided a computer-readable information storage medium storing the above-described download program.

(8) According to another aspect of the invention, there is provided a download system including a computer that downloads a program from a server through a network, the download system comprising:

a user identification information acquisition section that acquires a user identification (ID) information;

a download section that downloads a download file including a compressed target program determined based on the acquired user ID information from the server through the network, and stores the download file in a predetermined download file storage area;

an extraction section that extracts the compressed target program included in the download file stored in the predetermined download file storage area by the download; and

an installation program execution section that executes an installation program for installing the extracted target program in the computer.

(9) The download system according to another aspect of the invention may further comprise:

a file information acquisition section that acquires file information relating to the download file that can be downloaded,

wherein at least one of a download process, a compressed file extraction process, and an installation program execution process is performed by using the acquired file information.

(10) In the download system according to another aspect of the invention,

the download file may include a target program and an automatic installation program for installing the target program;

the automatic installation program may implement an automatic installation process that installs the target program at a predetermined installation destination without receiving input information from a user; and

the installation program execution section may execute the automatic installation program.

(11) In the download system according to another aspect of the invention,

the download section may receive the download file according to a predetermined file transfer protocol without using a web browser.

(12) In the download system according to another aspect of the invention,

the download section may include:

a program information request section that requests the server to transmit downloadable program information through the network based on the acquired user ID information;

an output section that outputs a download program selection screen based on the downloadable program information received from the server through the network in response to the request, the download program selection screen displaying a downloadable program list and accepting download program selection information;

a transfer request section that issues a file transfer request for the download file including the target program corresponding to the download program selection information accepted through the download program selection screen to the server through the network, based on the download program selection information; and

a download file storing section that stores the download file received in response to the file transfer request in the predetermined download file storage area.

(13) The download system according to another aspect of the invention may further comprise a decryption section that decrypts a downloaded encrypted program.

(14) According to another aspect of the invention, there is provided a download system including a server that downloads a program to a computer through a network, the download system comprising:

a download file storage section that stores a download file including a target program to be downloaded to the computer and an installation program for installing the target program;

a file information storage section that stores file information relating to the download file;

a user information setting/updating section that sets or updates user information relating to a relationship between the download file and a user identification (ID) information that can download the download file; and

a file transfer section that determines the download file to be downloaded based on the user ID information and the user information associated with a download request, and transfers the determined download file and the file information corresponding to the download file to the computer that has issued the download request through the network.

(15) The download system according to another aspect of the invention may further comprise:

a program selling section that receives the user ID information and a program purchase request including purchase target program identification information and payment information through the network, and performs a program selling process based on the program purchase request,

wherein the user information setting/updating section sets or updates the user information based on results of the program selling process.

When the program selling process has completed normally, the user information setting/updating section may register the product code and the like corresponding to the purchased program corresponding to the user ID information.

(16) The download system according to another aspect of the invention may further comprise:

a user registration section that receives the user ID information and user registration information including a serial code attached to an information storage medium which stores a program purchased by a user from the computer through the network, and performs a user registration process that stores user purchased program information associated with the user ID information based on the received user registration information,

wherein the download file storage section stores the download file having the program stored in the information storage medium as the target program; and

wherein the user information setting/updating section sets or updates the user information based on results of the user registration process.

According to this aspect of the invention, when the user has purchased an information storage medium (e.g., CD-ROM) that stores a program and performed a user registration process that stores the serial code attached to the information storage medium corresponding to the user ID information, the user information is automatically set or updated based on the user registration process results. Therefore, even when the user has purchased the information storage medium, the user can download the program stored in the information storage medium by utilizing the download program. This provides a user-friendly system that allows the user who has lost the purchased information storage medium to download the program from the server.

(17) In the download system according to another aspect of the invention,

the file transfer means may transfer an encrypted download file and the file information including decryption key information relating to the encrypted download file to the computer that has issued the download request through the network.

According to this aspect of the invention, since the encrypted download file cannot be decrypted when the encrypted download file has been downloaded without using the download program, a highly secure system cannot be provided.

(18) In the download system according to another aspect of the invention,

the user information may include license information relating to the download file and the user ID information that can download the download file; and

the file transfer section may perform a file transfer process based on the license information relating to the download file and the user ID information used to download the download file.

The license information includes information such as a license type that allows the user to download the download file to a plurality of computers, or a license type that allows the user to download the download file to one computer specified by the MAC address or the like.

The file transfer means may control whether or not to perform file transfer based on the license information relating to the download file and the user ID information used to download the download file, or may output a message corresponding to the license information during file transfer, for example.

(19) The download system according to another aspect of the invention, connected through the network to the computer, may further comprise:

a download program execution section that executes a download program installed in the computer that has issued the program purchase request at a predetermined timing based on the results of the program selling process,

the download program downloading a program from the server to the computer through the network and causing the computer to function as:

a user identification information acquisition section that acquires the user ID information;

a download section that downloads the download file including a compressed target program determined based on the acquired user ID information from the server through the network, and stores the download file in a predetermined download file storage area;

an extraction section that extracts the compressed target program included in the download file stored in the predetermined download file storage area by the download; and

an installation program execution section that executes an installation program for installing the extracted target program in the computer.

The predetermined timing may occur immediately after the setting, or may occur after a predetermined period of time. The download program execution section may transmits a command that causes the download program to be executed to the computer that has issued the purchase request, or a command causes the download process of the executed download program to start to execute the download program of the local computer.

For example, the download program may be added to startup items of the local computer during installation of the download program so that the download program is executed when the user has logged into the local computer and is resident in the local computer.

(20) According to another aspect of the invention, there is provided a download method of downloading a program from a server to a computer through a network, the download method comprising:

a download file storing step of storing a download file including a target program to be downloaded to the computer and an installation program for installing the target program in the server;

a step of storing file information relating to the download file in the server;

a user information setting/updating step of setting or updating user information relating to a relationship between the download file and a user identification (ID) information that can download the download file; and

a file transfer step of determining the download file to be downloaded based on the user ID information and the user information associated with a download request, and transferring the determined download file and the file information corresponding to the download file to the computer that has issued the download request through the network.

(21) The download method according to another aspect of the invention, downloading a program to the computer, may further comprise:

a program selling step of receiving the user ID information and a program purchase request including purchase target program identification information and payment information through the network, and performing a program selling process based on the program purchase request; and

a download program execution step of executing a download program installed in the computer that has issued the program purchase request at a predetermined timing based on results of the program selling process,

wherein the user information is set or updated based on the results of the program selling process in the user information setting/updating step; and

wherein the download program downloads a program from the server to the computer through the network and causes the computer to function as:

a user identification information acquisition section that acquires the user ID information;

a download section that downloads the download file including a compressed target program determined based on the acquired user ID information from the server through the network, and stores the download file in a predetermined download file storage area;

an extraction section that extracts the compressed target program included in the download file stored in the predetermined download file storage area by the download; and

an installation program execution section that executes an installation program for installing the extracted target program in the computer.

(22) The download method according to another aspect of the invention may further comprise:

a user registration step of receiving the user ID information and user registration information including a serial code attached to an information storage medium which stores a program purchased by a user from the computer through the network, and performing a user registration process that stores user purchased program information associated with the user ID information based on the received user registration information,

wherein the download file having the program stored in the information storage medium as the target program is stored in the download file storing step; and

wherein the user information is set or updated based on results of the user registration process in the user information setting/updating step.

(23) In the file transfer step of the download method according to another aspect of the invention,

an encrypted download file and the file information including decryption key information relating to the encrypted download file may be transferred to the computer that has issued the download request through the network.

(24) In the download method according to another aspect of the invention,

the user information may include license information relating to the download file and the user ID information that can download the download file in the user information setting/updating step; and

a file transfer process may be performed based on the license information relating to the download file and the user ID information used to download the download file in the file transfer step.

(25) The download method according to another aspect of the invention may comprise:

a step of installing a download program;

a step of causing the computer to acquire the user ID information;

a step of causing the computer to download the download file including a compressed target program determined based on the user ID information acquired by the computer from the server through the network, and store the download file in a predetermined download file storage area;

a step of causing the computer to extract the compressed target program included in the download file stored in the predetermined download file storage area by the download; and

a step of causing the computer to execute an installation program that installs the extracted target program in the computer,

the download program downloading a program from the server to the computer through the network and causing the computer to function as:

a user identification information acquisition section that acquires the user ID information;

a download section that downloads the download file including the compressed target program determined based on the acquired user ID information from the server through the network, and stores the download file in the predetermined download file storage area;

an extraction section that extracts the compressed target program included in the download file stored in the predetermined download file storage area by the download; and

an installation program execution section that executes the installation program for installing the extracted target program in the computer.

### BRIEF DESCRIPTION OF THE DRAWINGS

FIG. 1 is a diagram illustrative of an example of a download system according to one embodiment of the invention.

FIG. 2 shows an example of a functional block diagram of a server device of a download system according to one embodiment of the invention.

FIG. 3 is a diagram illustrative of product information, a download file, and file information stored in a database of a server according to one embodiment of the invention.

FIG. 4 is a diagram illustrative of user information stored in a database of a server according to one embodiment of the invention.

FIG. 5 shows an example of a functional block diagram of a user terminal according to one embodiment of the invention.

FIG. 6 is a diagram illustrative of a flow of a download process according to one embodiment of the invention.

FIG. 7 shows an example of a download screen.

FIG. 8 is a flowchart showing a process performed by a user from purchase to installation when using a download program.

FIG. 9 is a flowchart showing a process of a download program from purchase to installation when using the download program.

FIG. 10 is a flowchart showing a flow of a process of an automatic installation program.

FIG. 11 shows an example of an installation mode selection screen.

FIG. 12 is a flowchart showing a flow of a process of a server of a download system.

FIG. 13 is a flowchart showing a process of a download method according to one embodiment of the invention.

FIG. 14 is a flowchart showing an installation method using a commonly used installation program.

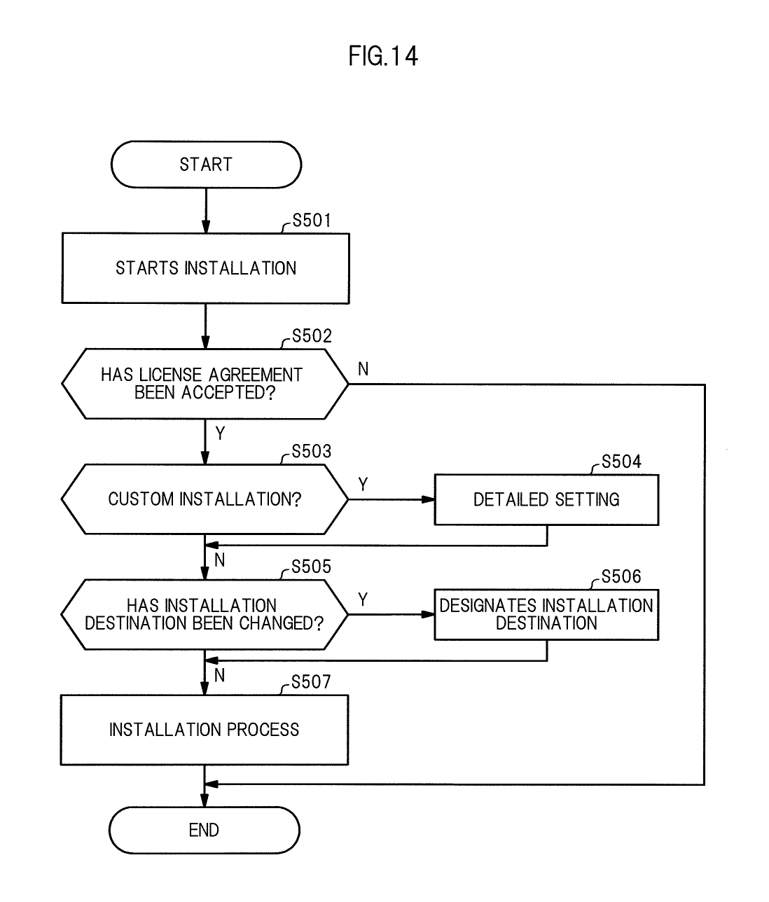

FIG. 15 is a flowchart showing a related-art download method.

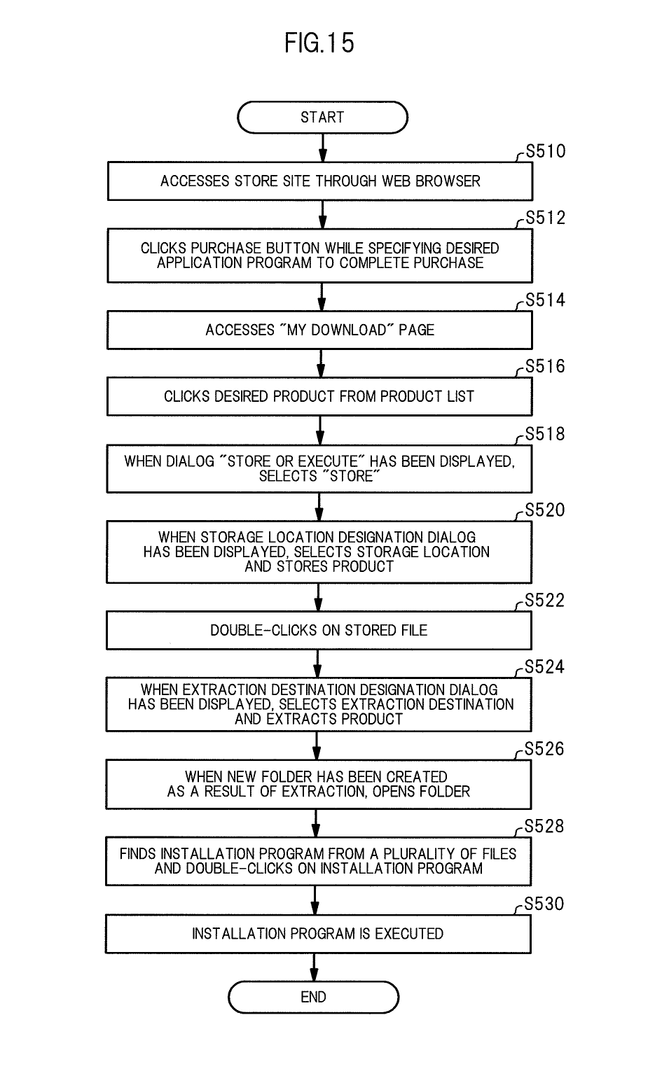

### BEST MODE FOR CARRYING OUT THE INVENTION

Preferred embodiments of the invention are described below with reference to the drawings.

### 1. Download System

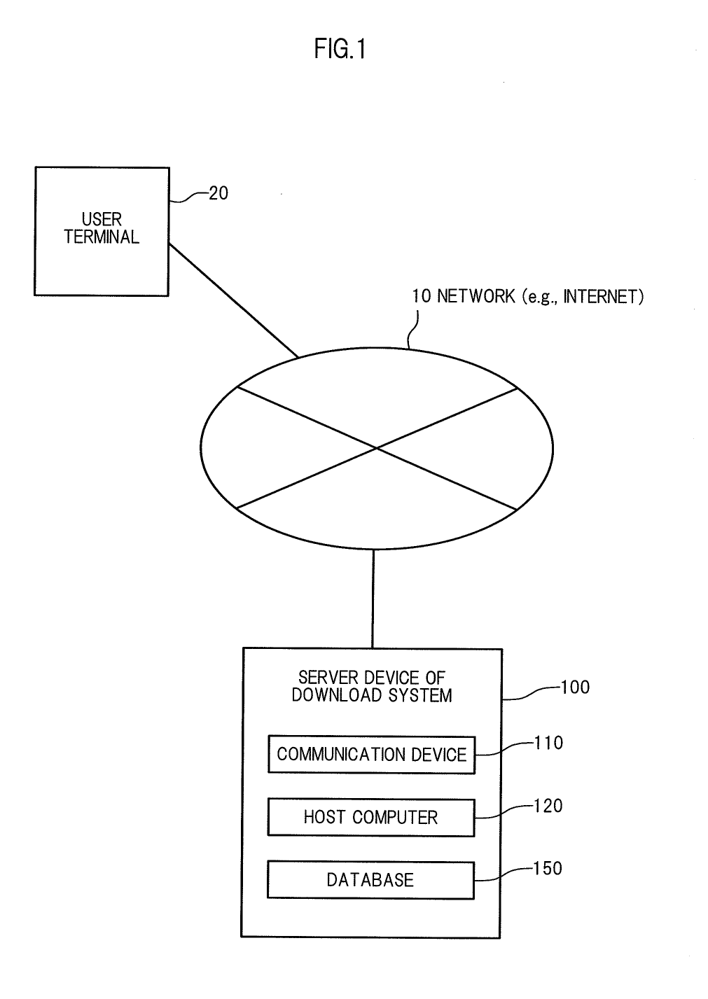

FIG. 1 is a diagram illustrative of an example of a download system according to one embodiment of the invention.

A download system according to this embodiment includes a server device 100 of the download system and a user information terminal (hereinafter referred to as “user terminal 20”). The server device 100 of the download system and the user terminal 20 are connected through a network 10 (e.g., Internet) via a network established by a provider, for example.

The transmission line of the network 10 may include a wireless transmission line, or may be a cable transmission line. A common line or a dedicated line may be used.

The server device 100 of the download system includes a communication device 110 that is connected to the Internet or the like and transmits and receives data, a host computer 120 such as a work station, and a database 150. The server device 100 of the download system also has a function of a Web server and the like, and provides a homepage corresponding to the world wide web (WWW) on the Internet.

The communication device 110 includes a modem, a terminal adapter a router, and the like. The communication device 110 exchanges data with another server device or terminal through a communication line such as a telephone line, an ISDN line, or a dedicated line.

The user terminal 20 is an information communication terminal (e.g., personal computer (PC), portable telephone, or PDA) possessed by the user. The user terminal 20 includes an input section, a control section, a display section, a communication section, and the like. A WWW browser is installed in the user terminal 20 so that the user can browse a homepage when the user terminal 20 is connected to the Internet. In this embodiment, a download program according to this embodiment is installed in the user terminal.

The user designates the uniform resource locator (URL) of the homepage on the site provided by the server device 100 of the download system using the user terminal 20 to access the homepage.

The user can purchase an application program product provided on the homepage of the site, and download the purchased program by executing the download program according to this embodiment on the user terminal.

When the user has purchased the application program product provided on the homepage of the site, the system may execute the download program installed in the user terminal which has issued a purchase request. For example, the download program may be added to startup items of a local computer during installation of the download program so that the download program is executed and is resident when the user has logged into the local computer, and a download program execution command may be transmitted to the computer that has issued the purchase request so that the local computer starts to download the purchased product.

This provides a system in which the purchased product is automatically downloaded even if the user does not execute the download program.

### 2. Server of Download System

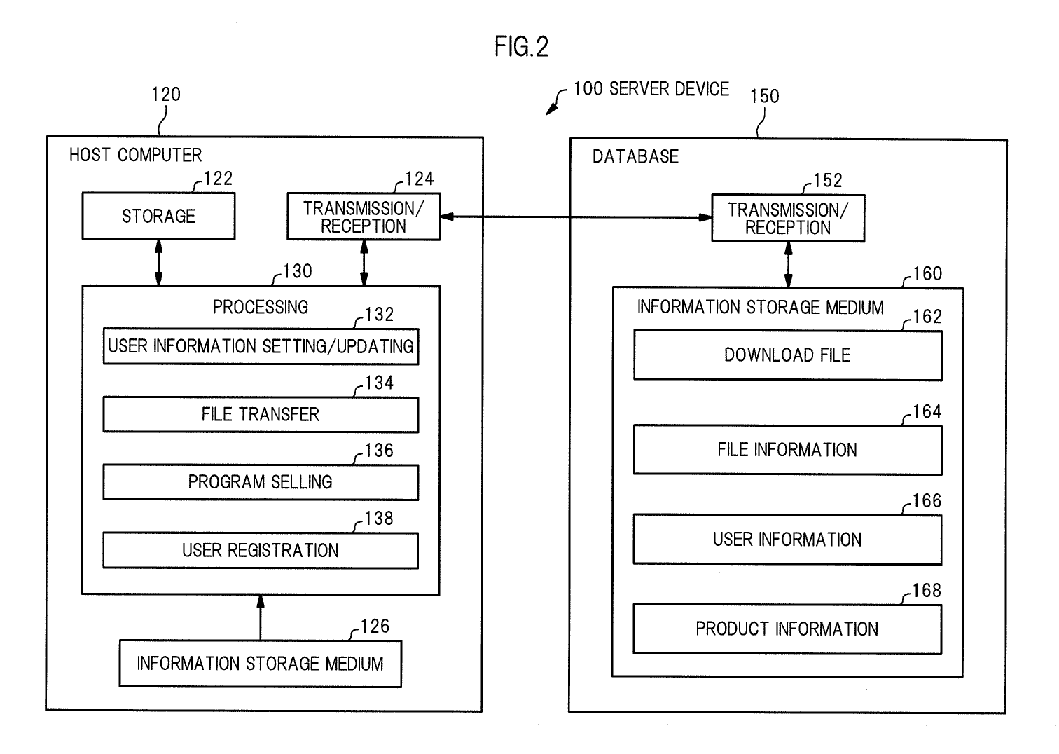

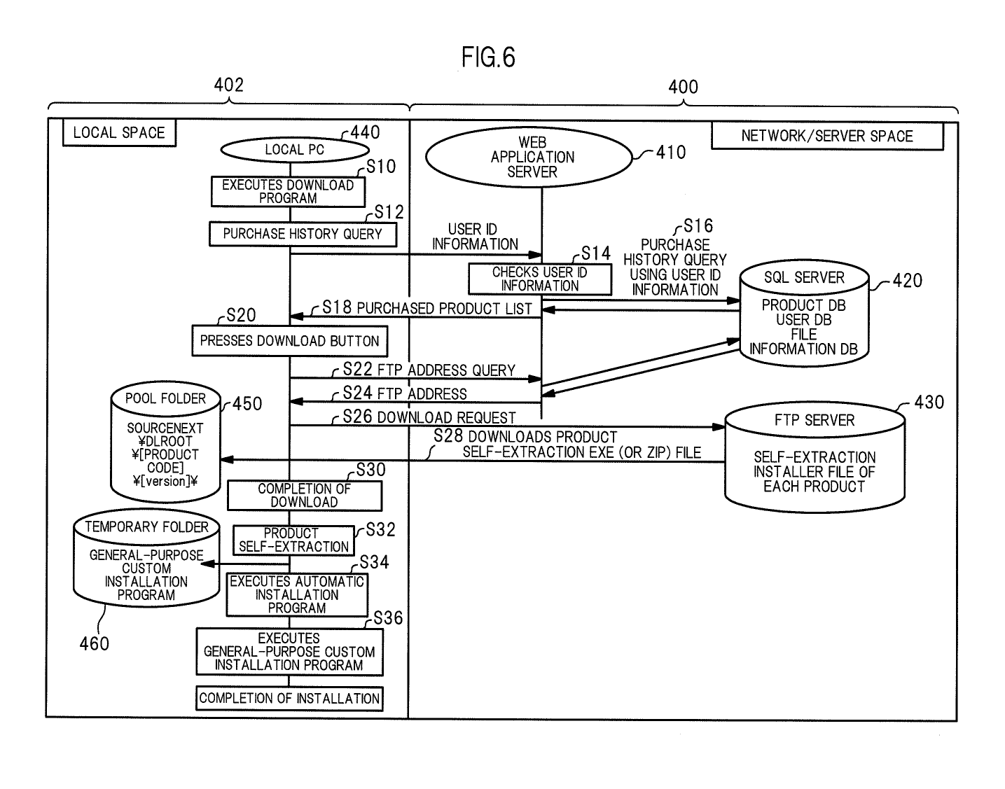

FIG. 2 shows an example of a functional block diagram of the server device 100 of the download system according to this embodiment. Note that the function of the server device 100 of the download system described below may be physically distributed among and executed by a plurality of computers, as shown in FIG. 6, for example.

The server device 100 of the download system includes a host computer 120 and a database 150.

The host controller 120 includes a processing section 130, a storage section 122, an information storage medium 126, and a transmission/reception section 124.

The transmission/reception section 124 exchanges data with the user terminal 20 and the database 150, and has a transmission function and a reception function. Note that a transmission means and a reception means may be separately provided to implement a transmission/reception function.

The storage section 122 serves as a work area for the processing section 130 and the transmission/reception section 124. The function of the storage section 122 is implemented by hardware such as a RAM.

The processing section 130 determines a terminal which has transmitted a request or determines a distribution request based on the received process request, and performs various processes. The function of the processing section 130 is implemented by hardware (processor (e.g., CPU or DSP) or ASIC (e.g., gate array)) and a program (e.g., game program or firmware). Note that the entire function of the processing section 130 may be implemented by hardware or a program.

The processing section 130 generates contents and image information for each terminal to display a homepage image based on process request information from each terminal. The image information is generated using a file (e.g., HTML file) described using a contents description language so that each terminal can display a Web page.

The processing section 130 may generate only contents and transmit the contents to the user information terminal, and the user information terminal may generate an image utilizing a Java applet, for example. Alternatively, the processing section 130 may generate contents described using XML and transmit the contents to the user information terminal, and the user information terminal may generate an image.

The processing section 130 performs various processes (e.g., updating an image on the homepage) based on various process requests.

The processing section 130 includes a user information setting/updating section 132, a file transfer section 134, a program selling section 136, and a user registration section 138.

The user information setting/updating section 132 sets or updates user information relating to the relationship between a download file and a user identification (ID) information that can download the download file.

The file transfer section 134 determines a download file based on the user ID information and the user information associated with the download request, and transfers the determined download file and file information corresponding to the download file to the computer that has issued the download request through the network.

The program selling section 136 receives the user ID information and a program purchase request including purchase target program identification information and payment information through the network, and performs a program selling process based on the program purchase request.

The user information setting/updating section 132 may set or update the user information based on the program selling process results.

The user registration section 138 performs a user registration process that receives the user ID information and user registration information including a serial code attached to an information storage medium which stores the program purchased by the user from a computer through the network, and stores user purchased program information corresponding to the user ID information based on the received user registration information. The user information setting/updating section 132 may set or update the user information based on the user registration process results.

The file transfer section 134 may transfer an encrypted download file and file information including decryption key information relating to the encrypted download file to the computer that has issued the download request through the network.

The user information may include license information relating to the download file and the user ID information that can download the download file, and the file transfer section 134 may perform the file transfer process based on the license information relating to the download file and the user ID information used to download the download file.

The processing section 130 may include a download program execution section (not shown) that executes the download program installed in the computer that has issued the purchase request at a predetermined timing based on the program selling process results.

The information storage medium (computer-usable storage medium) 126 stores information such as a program and data. The function of the information storage medium 126 may be implemented by hardware such as an optical disk (CD or DVD), a magneto-optical disk (MO), a magnetic disk, a hard disk, a magnetic tape, or a memory (ROM).

The processing section 130 performs various processes according to one aspect of the invention (this embodiment) based on information stored in the information storage medium 180. Specifically, the information storage medium 126 stores information (program or data) for implementing functions of one aspect of the invention (this embodiment) (particularly the blocks included in the processing section 130).

The above-described other functions may also be implemented by reading information from the information storage medium 126.

A program, data, and the like stored in the information recording medium 126 may be partially or entirely received through a transmission medium such as a network channel (line). Specifically, the host computer 120 may receive a program, data, and the like embodied in a carrier wave from a predetermined host terminal device or the like through the network instead of reading from the information storage medium 126 to implement the above-described functions, for example.

The database 150 includes a transmission/reception section 152 that exchanges data with the host computer 120, and an information storage section 60 that stores a download file 162, file information 164, user information 166, and product information 168. The database 150 functions as a download file database, a file information database, a user information database, and a product information database.

The information storage section 160 is a CPU-readable storage medium such as a magnetic storage medium, an optical storage medium, or a semiconductor memory. The information storage section 160 is implemented by a RAM, a hard disk (magnetic disk), a flexible disk, a CD-ROM, or the like.

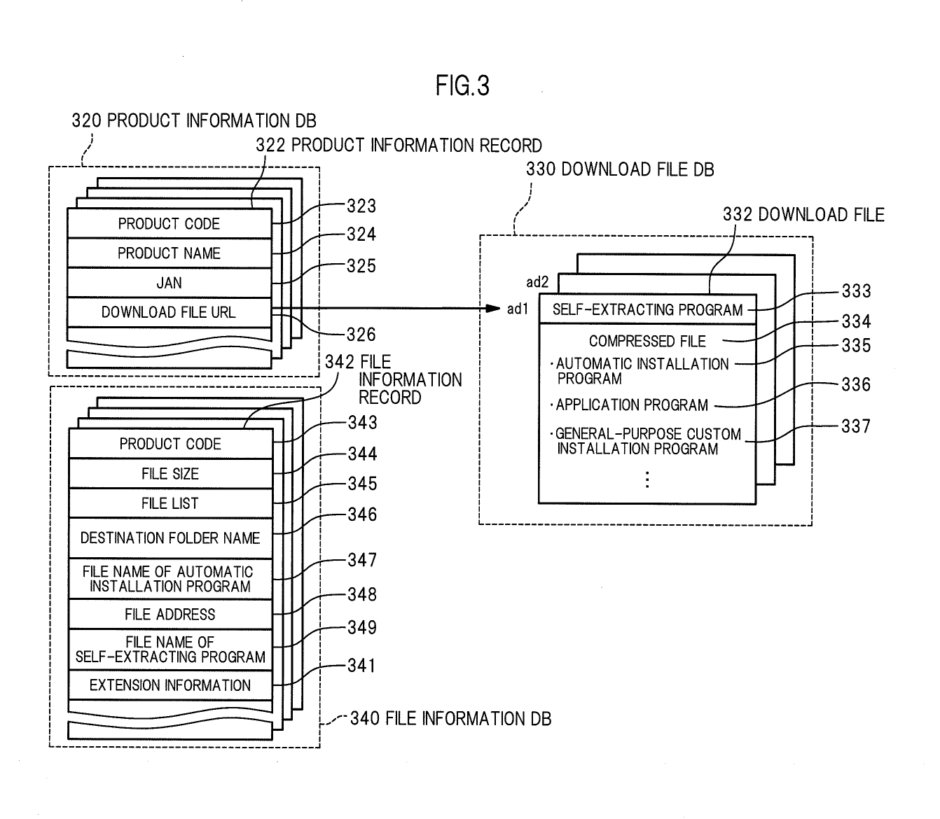

FIG. 3 is a diagram illustrative of product information, a download file, and file information stored in the database of the server according to this embodiment.

A product information database 320 includes a product information record 322 corresponding to each product (application program in this example). The product information record 322 includes information relating to a product code 323, a product name 324 corresponding to the product code, a JAN 325 corresponding to the product code, and a download file URL 326 corresponding to the product code. The product code is a code that specifies an application program product. The JAN 325 is a unique number assigned to each product for identification. The download file URL 326 is the address of a download file containing an application program corresponding to the product code.

A download file database 330 includes a download file including an executable file of an application program 336 corresponding to each product (application program in this example). A download file 332 may be an executable file (EXE file) that contains a compressed file 334 and an (uncompressed) self-extracting program 333 that self-extracts the compressed file 334.

The compressed file 334 includes an application program (i.e., target program) 226, an automatic installation program 335 for automatically installing the application program, a general-purpose custom installation program 337, and the like.

A file information database 340 includes a file information record 342 corresponding to each download file. The file information record 342 includes the product code 343 corresponding to the download file, a file size 344 of the download file 332, a file list 345 of the download file, an destination folder name 346, a file name 347 of the automatic installation program 335, an address (URL) 348 of the download file 332, a file name 349 of the self-extracting program 333, and extension information (e.g., information relating to whether or not a reboot is necessary) 341, and is expressed in an XML format or the like.

The local computer (i.e., user terminal) can automatically perform a download process, an extraction process, and an installation program execution process (without requiring input information from the user) by acquiring the file information relating to the download file. For example, the local computer may perform the download process based on the file address 348 and the file size 344 of the download file. The local computer may perform the extraction process based on the destination folder name 346, the file name 349 and the file list 345 of the self-extracting program. The local computer may perform the installation program execution process based on the destination folder name 346, the file name 347 and the file list 345 of the automatic installation program.

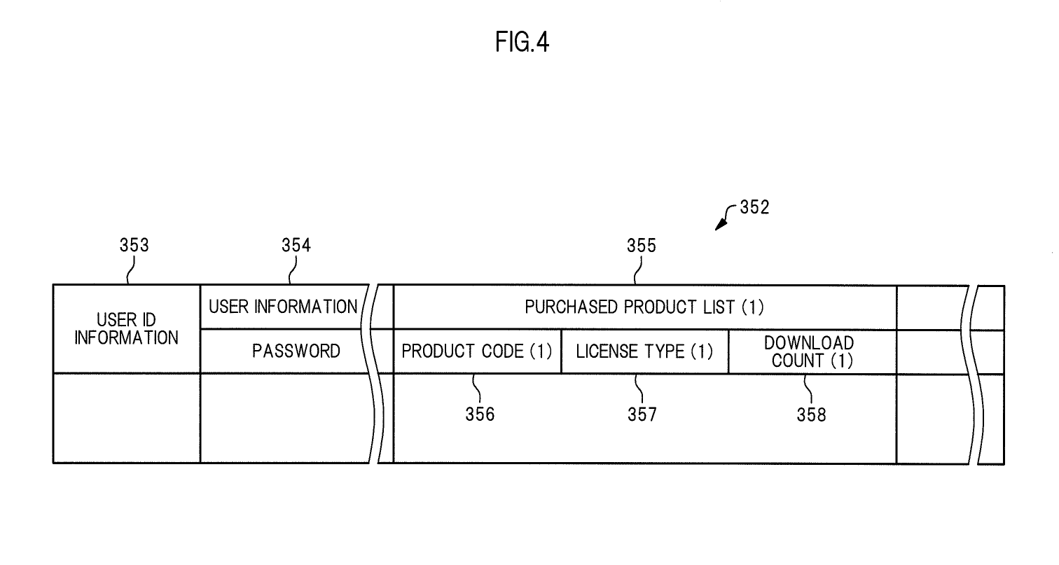

FIG. 4 is a diagram illustrative of the user information stored in the database of the server according to this embodiment.

The user information database includes a user information record 352 corresponding to each user. The user information record 352 includes a user ID information 353, user information (e.g., a password, a telephone number, a name, and a MAC address corresponding to the user ID information) 354, and a purchased product list 355 corresponding to the user ID information 353. The purchased product list 355 includes information relating to a product code 356 of the purchased product, license information 357 relating to the purchased product, a download count 358, and the like. The user information is set (a new user information record is generated) and updated (the existing user information record is rewritten) by the user information setting/updating section.

### 3. Configuration of User Terminal

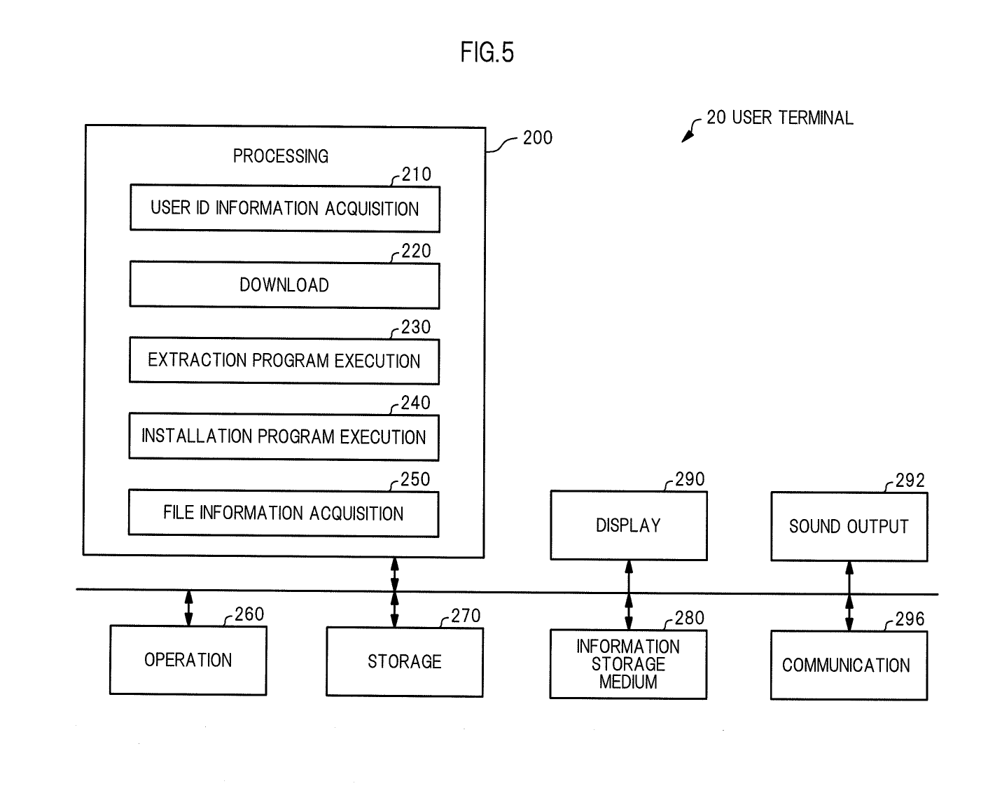

FIG. 5 shows an example of a functional block diagram of the user terminal (computer) 20 according to this embodiment. Note that the user terminal 20 according to this embodiment need not necessarily include all of the elements (sections) shown in FIG. 5. The user terminal 20 may have a configuration in which some of the elements are omitted.

An operation section 260 allows the user to input an operation as data. The function of the operation section 260 may be implemented by hardware such as a keyboard and a mouse.

A storage section 270 serves as a work area for a processing section 200, a communication section 296, and the like. The function of the storage section 270 may be implemented by hardware such as a RAM.

An information storage medium 280 (computer-readable medium) stores a program, data, and the like. The function of the information storage medium 280 may be implemented by hardware such as an optical disk (CD or DVD), a magneto-optical disk (MO), a magnetic disk, a hard disk, a magnetic tape, or a memory (ROM).

The information storage medium 280 stores auxiliary data (additional data) for a program that causes a computer to function as each section according to this embodiment.

The processing section 200 performs various processes according to this embodiment based on a program (data) stored in the information storage medium 280, data read from the information storage medium 280, and the like. Specifically, a program that causes a computer to function as each section according to this embodiment (program that causes a computer to execute the process of each section; e.g., download program) is stored in the information storage medium 280.

A display section 290 outputs an image generated according to this embodiment. The function of the display section 290 may be implemented by hardware such as a CRT display, a liquid crystal display (LCD), an organic EL display (OELD), a plasma display panel (PDP), or a touch panel display.

A sound output section 292 outputs sound generated according to this embodiment. The function of the sound output section 292 may be implemented by hardware such as a speaker or a headphone.

The communication section 296 performs various types of control for communicating with the outside (e.g., server device or another terminal). The function of the communication section 296 may be implemented by hardware such as a processor or a communication ASIC, a program, and the like.

A program (data) that causes a computer to function as each section according to this embodiment may be distributed to the information storage medium 280 (or storage section 270) from an information storage medium of a host device (server device) through a network and the communication section 296. Use of the information storage medium of the host device (e.g., server device) is also included within the scope of the invention.

The processing section 200 (processor) performs a file read/update/creation process, a display control process, and the like based on operation data from the operation section 260, a program, and the like. The processing section 200 performs various processes using the storage section 270 as a work area. The function of the processing section 200 may be implemented by hardware such as a processor (e.g., CPU or DSP) or an ASIC (e.g., gate array), an application program, or an OS (e.g., general-purpose OS).

The processing section 200 includes a user ID information acquisition section 210, a download section 220, an extraction program execution section 230, an installation program execution section 240, and a file information acquisition section 250.

The user ID information acquisition section 210 acquires the user ID information.

The download section 220 downloads a download file including a target program (i.e., download target) determined based on the acquired user ID information from the server through the network, and stores the download file in a predetermined download file storage area.

The extraction program execution section 230 extracts the compressed file included in the download file stored in the predetermined download file storage area.

The installation program execution section 240 executes the installation program for installing the extracted target program in the computer.

The file information acquisition section 250 acquires file information relating to the download file that can be downloaded. At least one of the download section 220 and the extraction program execution section 230 may perform a process using the acquired file information.

The download file may include a target program and an automatic installation program for installing the target program. The automatic installation program may be configured to implement an automatic installation process that installs the target program at a default installation destination set in advance without receiving input information from the user. The installation program execution section 240 may execute the automatic installation program.

The download section 220 may receive the download file according to a predetermined file transfer protocol without using a web browser.

The download section 220 may request the server to transmit downloadable program information through the network based on the acquired user ID information, output a download program selection screen that displays a downloadable program list and accepts download program selection information based on the downloadable program information received from the server through the network in response to the request, issue a file transfer request for the download file including the program corresponding to the download program selection information to the server through the network based on the download program selection information accepted through the download program selection screen, and store the download file received in response to the file transfer request in the predetermined download file storage area.

The processing section 200 may further include a decrypting section (not shown) that decrypts the downloaded encrypted program.

### 4. Flow of Download Process Performed by Download System

FIG. 6 is a diagram illustrative of a flow of the download process according to this embodiment.

Reference numeral 402 indicates the flow of the process performed by the user terminal (local computer) in a local space, and reference numeral 400 indicates the flow of the process performed by the server (web application server, SQL server, and FTP server) in a network/server space.

A web application server 410 is configured using ASP.NET that provides an execution environment for Web services and Web applications, and enables creation of dynamic Web pages using the same. The web application server 410 functions as a host computer.

An SQL server 420 stores the product information, the file information, and the user information. The SQL server 420 functions as the product information database, the file information database, and the user information database. The SQL server 420 is a database operated using a database language (query language) for manipulating and defining data in a relational database management system (RDBMS).

The user can purchase the application program through the Internet. For example, the information shown in FIG. 4 is stored as the user information regarding the product purchased by the user. A product which has been purchased by the user through a commercially-available CD-ROM and of which the serial No. attached to the CD-ROM and the user ID information have been registered is also registered as the user information.

An FTP server 430 is a server that transmits and receives a file using an FTP. The FTP server 430 stores the download file corresponding to each product, and functions as a download file database.

The download program according to this embodiment has been installed in a local computer 440 in advance.

When the user has executed the download program using the local computer at a predetermined timing (step S10), the download program inquires of the web application server about the purchase history corresponding to the user ID information through the network (step S12). The user ID information may be registered in the download program in advance, or the download program may issue an input request to the user and acquire the user ID information from the user.

When the web application server 410 has received an inquiry about the purchase history, the web application server 410 checks the corresponding user ID information (step S14), and inquires of the SQL server 420 about the purchase history corresponding to the user ID information (step S16). The SQL server 420 reads the product code registered in the purchased product list corresponding to the user ID information from the user information database, reads the product name corresponding to the product code from the product data base, generates the purchased product list, and transmits the purchased product list to the web application server.

The web application server 410 transmits the purchased product list received from the SQL server 420 in response to the purchase history query to the local computer 440 that has inquired of the web application server 410 about the purchase history through the network (step S18).

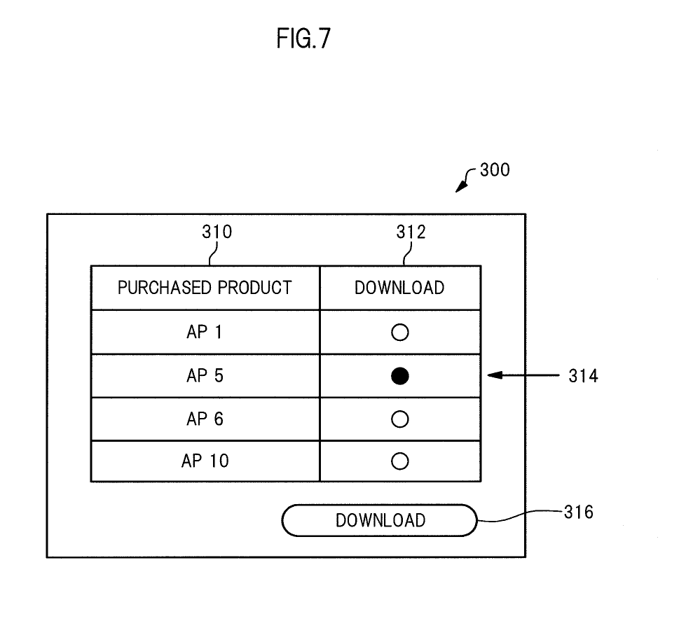

The local computer 440 generates a download screen 300 (see FIG. 7, for example) based on the received purchased product list, outputs the download screen 300 to the display section of the local computer 440, and accepts operation input information relating to download request product identification information, a download start instruction, and the like. For example, when a download check box 312 corresponding to a purchased product 310 has been selected and a download button 316 has been clicked (step S20), the product for which the download check box has been selected (see 314) may be download.

The download program of the local computer 440 inquires of the web application server 410 about the FTP address of the product for which the download check box has been selected through the network (step S22).

The web application server 410 that has received the FTP address query inquires of the SQL server 420 about the FTP address of the product. The SQL server 420 that has received the product FTP address query searches for the product database to acquire the product code corresponding to the product name, searches for the file information database to acquire the FTP address of the download file corresponding to the product code, and transmits the FTP address to the web application server 410.

The web application server 410 transmits the FTP address received from the SQL server 420 in response to the FTP address query to the local computer 440 that has inquired of the web application server 410 about the FTP address through the network (step S24).

The download program of the local computer 440 that has received the FTP address issues a download request for the download file at the FTP address to the FTP server 430 through the network (step S26).

The FTP server 430 that has received the download request transmits the download file at the corresponding FTP address to the local computer 440 that has transmitted the download request through the network using a predetermined file transfer protocol (e.g., FTP) without using a web browser (e.g., IE) (step S28).

The local computer 440 stores the received download file in a pool folder 450 (step S30). The pool folder 450 is a folder in which the download program stores the download file received in response to the download request. The pool folder 450 is allocated in advance by the download program.

The download program of the local computer 440 causes the download file to self-extract (step S32). Since the download file includes the self-extracting program (see FIG. 3), the download program can cause self-extraction by issuing a command for executing the self-extracting program. The self-extracted file is stored in a temporary folder 460.

Note that the file name of the self-extracting program may beset in advance according to a predetermined rule, and the download program may designate the name of the self-extracting program based on the predetermined rule to execute the self-extracting program. Alternatively, the download program may receive the file name of the self-extracting program of the download file when receiving the FTP address of the download file, and designate the received name of the self-extracting program to execute the self-extracting program.

The destination folder may be a folder allocated by the download program in advance, or the download program may receive the destination folder name stored as the file information when receiving the FTP address of the download file, and designate the received destination folder name to execute the self-extracting program.

The download program of the local computer 440 issues an execution command for the installation program included in the extracted file to execute the installation program (step S34).

Note that the file name of the installation program may be set in advance according to a predetermined rule, and the download program may designate the name of the installation program based on the predetermined rule to execute the installation program. Alternatively, the download program may receive the file name of the installation program of the download file when receiving the FTP address of the download file, and designate the received name of the installation program to execute the installation program.

When the general-purpose custom installation program has also been executed (step S36) and the user has designated custom installation when the installation program is executed, the process of the general-purpose custom installation program may be executed.

### 5. Flow of Process of Download Program

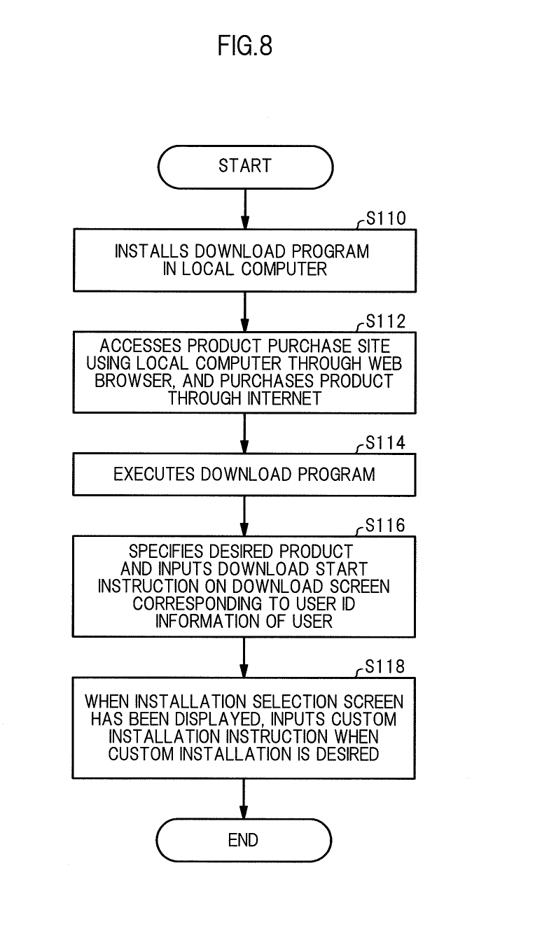

FIG. 8 is a flowchart showing the process performed by the user from purchase to installation when using the download program.

The user installs the download program in the local computer in advance (step S110). Note that only the download program may be installed, or the download program may be included in a product and may be installed in the local computer when installing the product.

The user accesses the product purchase site using the local computer through the WEB browser, and purchases a product (application program) through the Internet (step S112).

The user executes the download program (step S114).

The user then specifies the desired product and inputs a download start instruction on the download screen corresponding to the user ID information of the user (step S116).

When the installation selection screen has been displayed, the user inputs a custom installation instruction when the user desires custom installation (step S118).

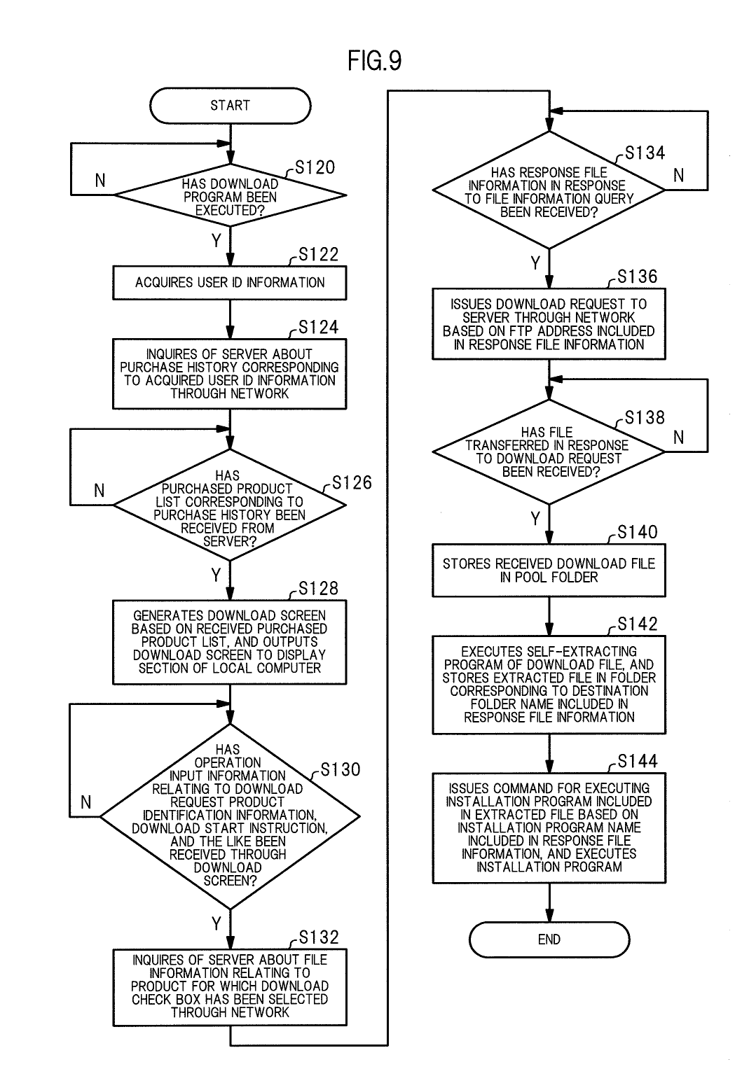

FIG. 9 is a flowchart showing the process of the download program from purchase to installation when using the download program.

When the download program has been executed on the local computer (step S120), the download program acquires the user ID information (step S122). The download program may output a user ID information input screen, and allow the user to input the user ID information to acquire the user ID information, for example. The user ID information registered when installing the download program may be used.

The download program inquiries of the web application server about the purchase history corresponding to the acquired user ID information through the network (step S124).

When the local computer has received the purchased product list corresponding to the purchase history (step S126), the local computer generates the download screen based on the received purchased product list, and outputs the download screen to the display section of the local computer (step S128).

When the local computer has received the operation input information relating to the download request product identification information, the download start instruction, and the like through the download screen (step S130), the download program of the local computer inquires of the web application server about the file information relating to the product for which the download check box has been selected through the network (step S132). The file information includes the FTP address and the file size of the download file, the destination folder name, the file name of the installation program, and the like.

When the local computer has received response file information in response to the file information query (step S134), the download program of the local computer issues a download request to the server through the network based on the FTP address included in the response file information (step S136).

When the local computer has received the file transferred in response to the download request (step S138), the local computer stores the received download file in the pool folder (step S140).

The download program of the local computer causes the download file to self-extract, and stores the extracted file in the folder corresponding to the destination folder name included in the response file information (step S142).

The download program of the local computer issues a command for executing the installation program included in the extracted file based on the installation program name included in the response file information to execute the installation program (step S144).

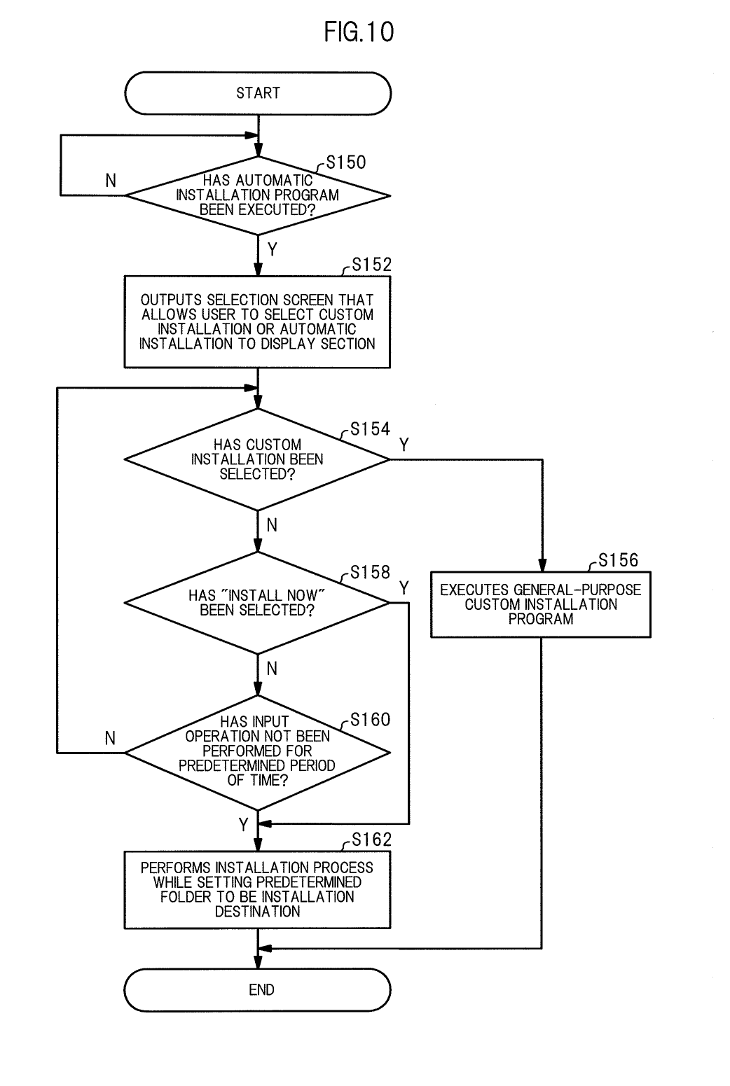

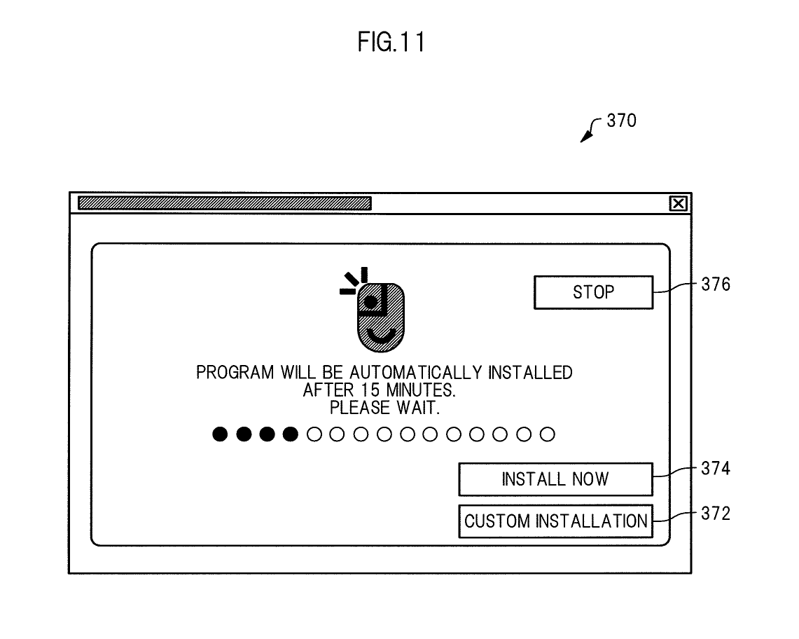

FIG. 10 is a flowchart showing the flow of the process of the automatic installation program. When the automatic installation program has been executed (step S150), an installation mode selection screen that allows the user to select custom installation or automatic installation is output to the display section (step S152). For example, an installation mode selection screen 370 shown in FIG. 11 is displayed. The installation mode selection screen 370 allows the user to select an item “custom installation” 372, an item. “install now (automatic installation)” 374, or an item “stop” 376.

When the item “custom installation” 372 has been selected (step S154), the general-purpose custom installation program is executed (step S156).

When the item “install now (automatic installation)” 374 has been selected or an input operation has not been performed for a specific period of time (steps S158 and S160), the installation process is performed while setting a predetermined folder to be the installation destination (step S162).

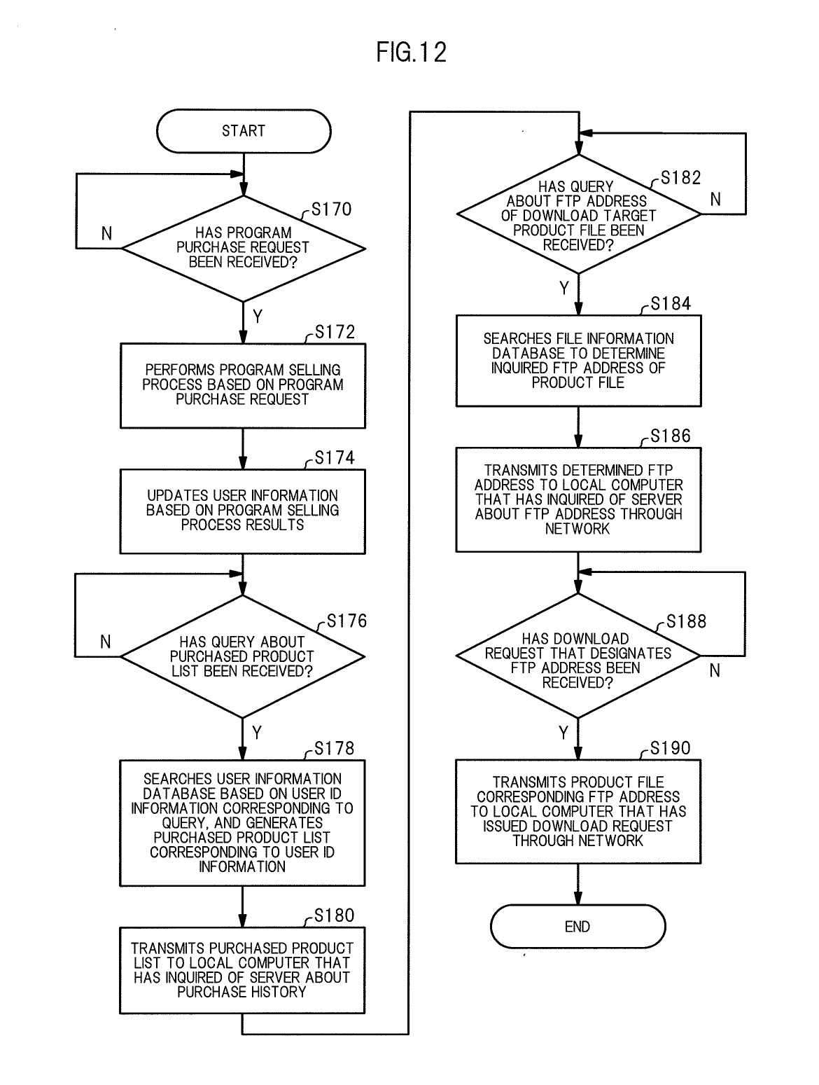

FIG. 12 is a flowchart showing the flow of the process of the server of the download system.

When the server has received the user ID information and the program purchase request including the purchase target program identification information and the payment information through the network (step S170), the server performs the program selling process based on the program purchase request (step S172).

The server updates the user information based on the program selling process results (step S174).

When the server has received a query about the purchased product list (step S176), the server searches the user information database based on the user ID information corresponding to the query about the purchased product list, and generates the purchased product list corresponding to the user ID information (step S178).

The server transmits the purchased product list to the local computer that has inquired of the server about the purchase history (step S180).

When the server has received a query about the FTP address of the download target product file (step S182), the server searches the file information database to determine the FTP address of the product file (step S184).

The server transmits the determined FTP address to the local computer that has inquired of the server about the FTP address (step S186).

When the server has received a download request that designates the FTP address (step S188), the server transmits the product file corresponding to the FTP address to the local computer that has issued the download request (step S190).

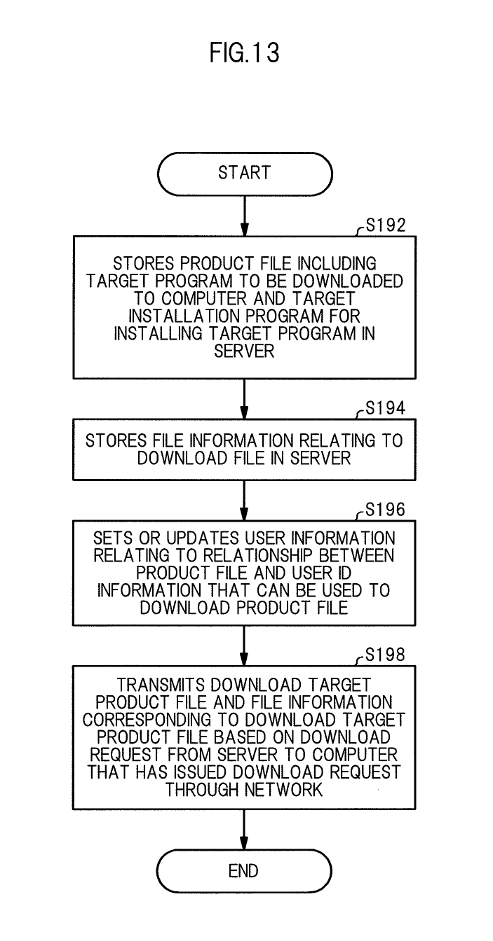

FIG. 13 is a flowchart showing the process of downloading a program from the server to the terminal computer through the network.

A download file including a target program downloaded to the computer and a target installation program for installing the target program (application program), is stored in the server (step S192).

The file information that stores the file information relating to the download file is stored in the server (step S194).

The user information relating to a relationship between the download file and the user ID information that can download the download file is set or updated (step S196).

The download file is determined based on the user ID information and the user information associated with the download request, and the download file and the file information corresponding to the download file are transferred from the server to the computer that has issued the download request through the network (step S198).

The invention includes configurations substantially the same as the configurations described in the embodiments (in function, in method and effect, or in objective and effect). The invention also includes a configuration in which an unsubstantial section of the above-described embodiments is replaced by another section. The invention also includes a configuration having the same effects as those of the above-described configurations, or a configuration capable of achieving the same object as those of the above-described configurations. Further, the invention includes a configuration obtained by adding known technology to the above-described configurations.

The invention is not limited to the above-described embodiments. Various modifications and variations may be made without departing from the scope of the invention.

For example, the download program may have a decryption function of decrypting the downloaded encrypted program. An encrypted download file and a key may be transferred during downloading, and the encrypted download file may be decrypted by the download program. This implements a system in which a file downloaded without using the download program cannot be decrypted.

When the user has purchased an information storage medium (e.g., CD-ROM) that stores a program and performed a user registration process that stores the serial code attached to the information storage medium corresponding to the user ID information, the user information may be automatically set or updated based on the user registration process results. In this case, even when the user has purchased an information storage medium (e.g. CD-ROM) that stores an application program at a store, the user can download the program stored in the information storage medium by utilizing the download program. This provides a user-friendly system that allows a user who has lost the purchased information storage medium to download the program from the server.

1. A download program that downloads a program from a server to a computer through a network, the download program causing the computer to function as:
a user identification information acquisition section that acquires a user identification (ID) information;
a download section that downloads a download file including a compressed target program determined based on the acquired user ID information from the server through the network, and stores the download file in a predetermined download file storage area;
an extraction section that extracts the compressed target program included in the download file stored in the predetermined download file storage area by the download; and
an installation program execution section that executes an installation program for installing the extracted target program in the computer.

2. The download program as defined in claim 1, further comprising:
a file information acquisition section that acquires file information relating to the download file that can be downloaded,
wherein at least one of a download process, a compressed file extraction process, and an installation program execution process is performed by using the acquired file information.

3. The download program as defined in claim 1, wherein:
the download file includes a target program and an automatic installation program for installing the target program;
the automatic installation program implements an automatic installation process that installs the target program at a predetermined installation destination without receiving input information from a user; and
the installation program execution section executes the automatic installation program.

4. The download program as defined in claim 1,
wherein the download section receives the download file according to a predetermined file transfer protocol without using a web browser.

5. The download program as defined in claim 1,
wherein the download section includes:
a program information request section that requests the server to transmit downloadable program information through the network based on the acquired user ID information;
an output section that outputs a download program selection screen based on the downloadable program information received from the server through the network in response to the request, the download program selection screen displaying a downloadable program list and accepting download program selection information;
a transfer request section that issues a file transfer request for the download file including the target program corresponding to the download program selection information accepted through the download program selection screen to the server through the network, based on the download program selection information; and
a download file storing section that stores the download file received in response to the file transfer request in the predetermined download file storage area.

6. The download program as defined in claim 1, further comprising:
a decryption section that decrypts a downloaded encrypted program.

7. A computer-readable information storage medium storing the download program as defined in claim 1.

8. A download system including a computer that downloads a program from a server through a network, the download system comprising:
a user identification information acquisition section that acquires a user identification (ID) information;
a download section that downloads a download file including a compressed target program determined based on the acquired user ID information from the server through the network, and stores the download file in a predetermined download file storage area;
an extraction section that extracts the compressed target program included in the download file stored in the predetermined download file storage area by the download; and
an installation program execution section that executes an installation program for installing the extracted target program in the computer.

9. The download system as defined in claim 8, further comprising:
a file information acquisition section that acquires file information relating to the download file that can be downloaded,
wherein at least one of a download process, a compressed file extraction process, and an installation program execution process is performed by using the acquired file information.

10. The download system as defined in claim 8, wherein:
the download file includes a target program and an automatic installation program for installing the target program;
the automatic installation program implements an automatic installation process that installs the target program at a predetermined installation destination without receiving input information from a user; and
the installation program execution section executes the automatic installation program.

11. The download system as defined in claim 8,
wherein the download section receives the download file according to a predetermined file transfer protocol without using a web browser.

12. The download system as defined in claim 8,
wherein the download section includes:
a program information request section that requests the server to transmit downloadable program information through the network based on the acquired user ID information;
an output section that outputs a download program selection screen based on the downloadable program information received from the server through the network in response to the request, the download program selection screen displaying a downloadable program list and accepting download program selection information;
a transfer request section that issues a file transfer request for the download file including the target program corresponding to the download program selection information accepted through the download program selection screen to the server through the network, based on the download program selection information; and
a download file storing section that stores the download file received in response to the file transfer request in the predetermined download file storage area.

13. The download system as defined in claim 8, further comprising:
a decryption section that decrypts a downloaded encrypted program.

14. A download system including a server that downloads a program to a computer through a network, the download system comprising:
a download file storage section that stores a download file including a target program to be downloaded to the computer and an installation program for installing the target program;
a file information storage section that stores file information relating to the download file;
a user information setting/updating section that sets or updates user information relating to a relationship between the download file and a user identification (ID) information that can download the download file; and
a file transfer section that determines the download file to be downloaded based on the user ID information and the user information associated with a download request, and transfers the determined download file and the file information corresponding to the download file to the computer that has issued the download request through the network.

15. The download system as defined in claim 14, further comprising:
a program selling section that receives the user ID information and a program purchase request including purchase target program identification information and payment information through the network, and performs a program selling process based on the program purchase request,
wherein the user information setting/updating section sets or updates the user information based on results of the program selling process.

16. The download system as defined in claim 14, further comprising:
a user registration section that receives the user ID information and user registration information including a serial code attached to an information storage medium which stores a program purchased by a user from the computer through the network, and performs a user registration process that stores user purchased program information associated with the user ID information based on the received user registration information,
wherein the download file storage section stores the download file having the program stored in the information storage medium as the target program; and
wherein the user information setting/updating section sets or updates the user information based on results of the user registration process.

17. The download system as defined in claim 14,
wherein the file transfer section transfers an encrypted download file and the file information including decryption key information relating to the encrypted download file to the computer that has issued the download request through the network.

18. The download system as defined in claim 14,
wherein the user information includes license information relating to the download file and the user ID information that can download the download file; and
wherein the file transfer section performs a file transfer process based on the license information relating to the download file and the user ID information used to download the download file.

19. The download system as defined in claim 15, the download system being connected through the network to the computer and further comprising:
a download program execution section that executes a download program installed in the computer that has issued the program purchase request at a predetermined timing based on the results of the program selling process,
the download program downloading a program from the server to the computer through the network and causing the computer to function as:
a user identification information acquisition section that acquires the user ID information;
a download section that downloads the download file including a compressed target program determined based on the acquired user ID information from the server through the network, and stores the download file in a predetermined download file storage area;
an extraction section that extracts the compressed target program included in the download file stored in the predetermined download file storage area by the download; and
an installation program execution section that executes an installation program for installing the extracted target program in the computer.

20. A download method of downloading a program from a server to a computer through a network, the download method comprising:
a download file storing step of storing a download file including a target program to be downloaded to the computer and an installation program for installing the target program in the server;
a step of storing file information relating to the download file in the server;
a user information setting/updating step of setting or updating user information relating to a relationship between the download file and a user identification (ID) information that can download the download file; and
a file transfer step of determining the download file to be downloaded based on the user ID information and the user information associated with a download request, and transferring the determined download file and the file information corresponding to the download file to the computer that has issued the download request through the network.

21. The download method as defined in claim 20, downloading a program to the computer and further comprising:
a program selling step of receiving the user ID information and a program purchase request including purchase target program identification information and payment information through the network, and performing a program selling process based on the program purchase request; and
a download program execution step of executing a download program installed in the computer that has issued the program purchase request at a predetermined timing based on results of the program selling process,
wherein the user information is set or updated based on the results of the program selling process in the user information setting/updating step; and
wherein the download program downloads a program from the server to the computer through the network and causes the computer to function as:
a user identification information acquisition section that acquires the user ID information;
a download section that downloads the download file including a compressed target program determined based on the acquired user ID information from the server through the network, and stores the download file in a predetermined download file storage area;
an extraction section that extracts the compressed target program included in the download file stored in the predetermined download file storage area by the download; and
an installation program execution section that executes an installation program for installing the extracted target program in the computer.

22. The download method as defined in claim 20, further comprising:
a user registration step of receiving the user ID information and user registration information including a serial code attached to an information storage medium which stores a program purchased by a user from the computer through the network, and performing a user registration process that stores user purchased program information associated with the user ID information based on the received user registration information, wherein the download file having the program stored in the information storage medium as the target program is stored in the download file storing step; and
wherein the user information is set or updated based on results of the user registration process in the user information setting/updating step.

23. The download method as defined in claim 20,
wherein, in the file transfer step, an encrypted download file and the file information including decryption key information relating to the encrypted download file are transferred to the computer that has issued the download request through the network.

24. The download method as defined in claim 20,
wherein, in the user information setting/updating step, the user information includes license information relating to the download file and the user ID information that can download the download file; and
wherein, in the file transfer step, a file transfer process is performed based on the license information relating to the download file and the user ID information used to download the download file.

25. The download method as defined in claim 20, comprising:
a step of installing a download program;
a step of causing the computer to acquire the user ID information;
a step of causing the computer to download the download file including a compressed target program determined based on the user ID information acquired by the computer from the server through the network, and store the download file in a predetermined download file storage area;
a step of causing the computer to extract the compressed target program included in the download file stored in the predetermined download file storage area by the download; and
a step of causing the computer to execute an installation program that installs the extracted target program in the computer,
the download program downloading a program from the server to the computer through the network and causing the computer to function as:
a user identification information acquisition section that acquires the user ID information;
a download section that downloads the download file including the compressed target program determined based on the acquired user ID information from the server through the network, and stores the download file in the predetermined download file storage area;
an extraction section that extracts the compressed target program included in the download file stored in the predetermined download file storage area by the download; and
an installation program execution section that executes the installation program for installing the extracted target program in the computer.
